(19) United States
(12) Patent Application Publication
(10) Pub. No.: US 2024/0113985 A1
(43) Pub. Date: Apr. 4, 2024

(54) Techniques For Managing Packet Scheduling From Queue Circuits

(71) Applicant: Altera Corporation, San Jose, CA (US)

(72) Inventors: Kenneth Taylor, Newark, CA (US); Robert Critchlow, Marlow (GB)

(73) Assignee: Altera Corporation, San Jose, CA (US)

(21) Appl. No.: 18/538,386

(22) Filed: Dec. 13, 2023

(51) Int. Cl. H04L 47/52; H04L 47/12; H04L 47/6295

(52) U.S. Cl. CPC H04L 47/527; H04L 47/12; H04L 47/6295

(57) ABSTRACT

An integrated circuit includes queue circuits for storing packets, a scheduler circuit that schedules the packets received from the queue circuits to be provided in an output, and a traffic manager circuit that disables one of the queue circuits from transmitting any of the packets to the scheduler circuit based at least in part on a bandwidth in the output scheduled for a subset of the packets received from the one of the queue circuits.

### TECHNICAL FIELD

The present disclosure relates to electronic circuits, and more particularly to techniques for managing packet scheduling from queue circuits.

### BACKGROUND

Configurable integrated circuits can be configured by users to implement desired custom logic functions. In a typical scenario, a logic designer uses computer-aided design (CAD) tools to design a custom circuit design. When the design process is complete, the computer-aided design tools generate configuration data. The configuration data is then loaded into configuration memory elements that configure configurable logic circuits in the integrated circuit to perform the functions of the custom circuit design. Configurable integrated circuits can be used for co-processing in big-data or fast-data applications. For example, configurable integrated circuits can be used in application acceleration tasks in a datacenter and can be reprogrammed during datacenter operation to perform different tasks.

### BRIEF DESCRIPTION OF DRAWINGS

FIG. 1 is a diagram that depicts an example of a packet scheduler circuit that can implement fair queueing of incoming packets at high packet rates.

FIG. 2 is a diagram that depicts details of an example of a portion of the traffic manager circuit of FIG. 1.

FIG. 3 is a diagram that depicts details of an example of the deficit allowance circuit of FIG. 2.

FIG. 4 is a diagram that depicts a graph illustrating examples of the deficit count values and bandwidths for packets sent from queues in the packet scheduler circuit of FIG. 1.

FIG. 5 illustrates an example of a programmable logic integrated circuit (IC) that can include the circuitry disclosed herein with respect to any one or more of FIGS. 1-3.

FIG. 6A illustrates a block diagram of a system that can be used to implement a circuit design to be programmed onto a programmable logic device using design software.

FIG. 6B is a diagram that depicts an example of the programmable logic device that includes three fabric die and two base die that are connected to one another via microbumps.

FIG. 7 is a block diagram illustrating a computing system configured to implement one or more aspects of the embodiments disclosed herein.

### DETAILED DESCRIPTION

A packet scheduler (also referred to as a network scheduler) is an arbiter on a node in a packet switching communication network. Packet schedulers often use Fair Queuing algorithms, such as Deficit Round Robin (DRR), that strive to ensure that packets are scheduled to be sent to different destinations across a shared link (via Virtual Output Queues or VOQs) in a way that equalizes the fraction of bandwidth used between different data streams, because basic round robin scheduling can result in unfair queueing where data streams with larger packets use more bandwidth. However, DRR algorithms typically require many comparisons and arithmetic operations to be performed for each packet to be sent. A DRR algorithm is usually described as implemented by software, i.e., by loops iterating over scheduling rounds. A DRR algorithm typically takes many computing cycles to make a packet scheduling decision.

Implementing a DRR algorithm on a relatively slow hardware platform, such as a field programmable gate array (FPGA), given the number of inputs into the calculation, requires either several cycles of calculation per packet, or operation at low enough frequencies to handle many layers of logic. The DRR algorithm calculation cannot be pipelined to increase throughput, because each scheduling decision affects deficit counter values and active queue lists required for the next immediate scheduling decision, resulting in a critical feedback path.

To take full advantage of faster data links, such as 200 Gigabit, 400 Gigabit, and 800 Gigabit Ethernet, a packet scheduler needs to make packet scheduling decisions in less time (e.g., one decision per clock cycle). However, a DRR Fair Queueing algorithm cannot make packet scheduling decisions in short enough time periods for these faster data links.

To solve this problem, a packet scheduler is provided that implements fair queueing for incoming packets. In some examples, the packet scheduler includes a basic round robin scheduler that makes packet scheduling decisions for incoming packets stored in queues. In some implementations, the packet scheduler is implemented with single-cycle-per-packet throughput performance. A downstream traffic manager circuit compares bandwidth used by each of the queues to an ideal fair-queueing result, and selectively throttles or disables queues that are over-allocated. The packet scheduler can achieve a fair queuing result, but in a latency-insensitive manner that can be highly pipelined to achieve single packet-per-cycle throughput.

The packet scheduler removes deficit calculation from the critical inner loop of the basic round robin scheduler to allow scaling to higher packet rates and larger queue counts without impacting maximum frequency.

One or more specific examples are described below. In an effort to provide a concise description of these examples, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Throughout the specification, and in the claims, the term “connected” means a direct electrical connection between the circuits that are connected, without any intermediary devices. The term “coupled” means either a direct electrical connection between circuits or an indirect electrical connection through one or more passive or active intermediary devices that allows the transfer of information between circuits. The term “circuit” may mean one or more passive and/or active electrical components that are arranged to cooperate with one another to provide a desired function.

This disclosure discusses integrated circuit devices, including configurable (programmable) logic integrated circuits, such as field programmable gate arrays (FPGAs). As discussed herein, an integrated circuit (IC) can include hard logic and/or soft logic. The circuits in an integrated circuit device (e.g., in a configurable logic IC) that are configurable by an end user are referred to as “soft logic.” As used herein, “hard logic” generally refers to circuits in an integrated circuit device that are not configurable by an end user or have less configurable features than soft logic.

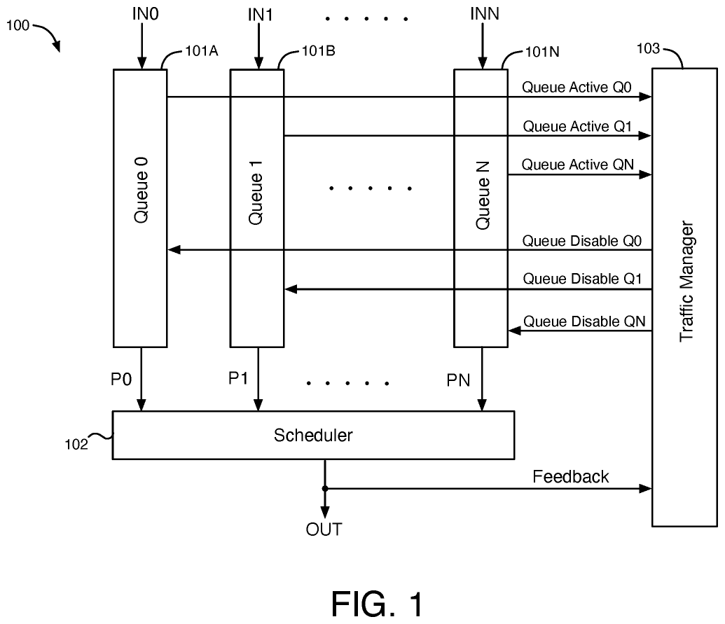

FIG. 1 is a diagram that depicts an example of a packet scheduler circuit 100 that can implement fair queueing of incoming packets at high packet rates. The packet scheduler circuit 100 can be provided in any type of integrated circuit (IC), such as a configurable IC (e.g., an FPGA), a microprocessor IC, a graphics processing unit IC, a memory IC, an application specific IC, a transceiver IC, a memory IC, etc. As a specific example, the packet scheduler circuit 100 can be implemented by soft logic in an FPGA. Alternatively, the packet scheduler 100 can be formed in multiple integrated circuits in a circuit system.

The packet scheduler circuit 100 of Figure (FIG. 1 includes an N number of queue circuits 101A, 1018, . . . 101N that are collectively referred to herein as queue circuits 101 or queues 101, where N is any integer number greater than 1. The packet scheduler circuit 100 also includes a scheduler circuit 102 (e.g., a round robin scheduler) and a traffic manager circuit 103 that are coupled as shown in FIG. 1. The queue circuits 101A, 1018, . . . 101N receive an N number of input signals IN0, IN1, . . . INN, respectively, as shown in FIG. 1. Each of the input signals IN0, IN1, . . . INN is representative of bits in one or more packets. Packets are provided to each of the queues 101 serially or in parallel. Each of the queues 101 includes memory (e.g., a storage circuit, such as a first-in-first-out (FIFO) buffer) that stores a respective one or more of the packets for a period of time. The queue circuits 101A, 1018, . . . 101N output an N number of the packets to the scheduler circuit 102 as an N number of output signals P0, P1, . . . PN, respectively, as allowed by the traffic manager circuit 103, which is described in detail below.

In an exemplary implementation, the scheduler circuit 102 implements a basic round robin scheduler algorithm that is designed to achieve a targeted packet rate, such as one packet per clock cycle, without taking into account packet sizes. The scheduler circuit 102 receives the packets stored in the queues 101 as signals P0, P1, . . . PN when the respective queues 101 are active and not disabled by the traffic manager circuit 103. The scheduler circuit 102 schedules and outputs the packets indicated by output signals P0, P1, . . . PN in series in output signal OUT. The output signal OUT of the scheduler circuit 102 is also provided to an input of the traffic manager circuit 103 as a Feedback signal. Thus, the output signal OUT (also referred to as the Feedback signal) indicates bits in one of the packets from one of the queues 101 in each predefined time interval. Over enough of the time intervals, the scheduler circuit 102 outputs packets from each of the queues 101 in output signal OUT, such that the packets are output serially one after the other.

The traffic manager circuit 103 monitors sizes of the packets using the Feedback signal and Queue Active signals Q0, Q1, . . . QN received from the queue circuits 101A, 1016, . . . 101N, respectively. The traffic manager circuit 103 can throttle, or disable, the queues 101 from sending packets to the scheduler circuit 102 for scheduling using Queue Disable signals Q0, Q1, . . . QN that are provided to the queue circuits 101A, 1016, . . . 101N, respectively. Traffic manager circuit 103 can implement several traffic throttling strategies in parallel including a simple bandwidth shaper that compares queue bandwidth usage against an absolute bandwidth limit set by an application. In an exemplary implementation, the traffic throttling pattern achieved by packet scheduling circuit 100 converges to the same average long-term result as a Deficit Round Robin queuing algorithm. This result may not be based on absolute bandwidth usage, but instead can be dynamically determined by the number of active queues 101 and the historical packet sizes the queues 101 have sent, as described in further detail below.

The packet scheduler circuit 100 implements an algorithm that causes the pace of all of the queues 101 to be throttled to the rate of the slowest continuously active queue among queues 101, which is typically the queue storing the smallest packets. Therefore, the queues with larger packets are throttled, and smaller packets are allowed to be scheduled and output by the scheduler circuit 102, resulting in a long-term average of all queues 101 sharing the available output bandwidth of OUT equally for whatever packet sizes are being sent.

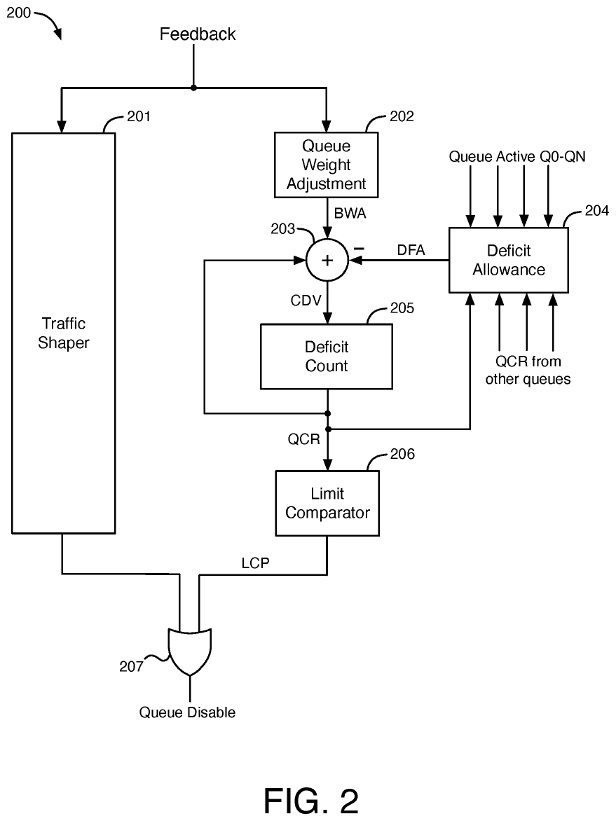

FIG. 2 is a diagram that depicts details of an example of a portion 200 of the traffic manager circuit 103. In the example of FIG. 2, the portion 200 of the traffic manager circuit 103 includes a traffic shaper circuit 201, a queue weight adjustment circuit 202, an adder circuit 203, a deficit allowance circuit 204, a deficit count circuit 205, a limit comparator circuit 206, and an OR gate logic circuit 207. The traffic manager circuit 103 includes a portion 200 as shown in FIG. 2 for each of the queues 101. Thus, traffic manager circuit 103 of FIG. 1 includes an N number of the portions 200, each including the circuits 201-207 coupled together as shown in FIG. 2, for the N number of queues 101. The portion 200 for each respective one of the queues 101A-101N is responsive to the Feedback signal indicating a packet from that respective one of the queues 101A-101N and generates the Queue Disable signal for that respective one of the queues 101A-101N. As an example, the portion 200 of traffic manager circuit 103 for queue circuit 101A is responsive to the Feedback signal when the Feedback signal indicates a packet received from queue circuit 101A and generates the Queue Disable Q0 signal for queue circuit 101A.

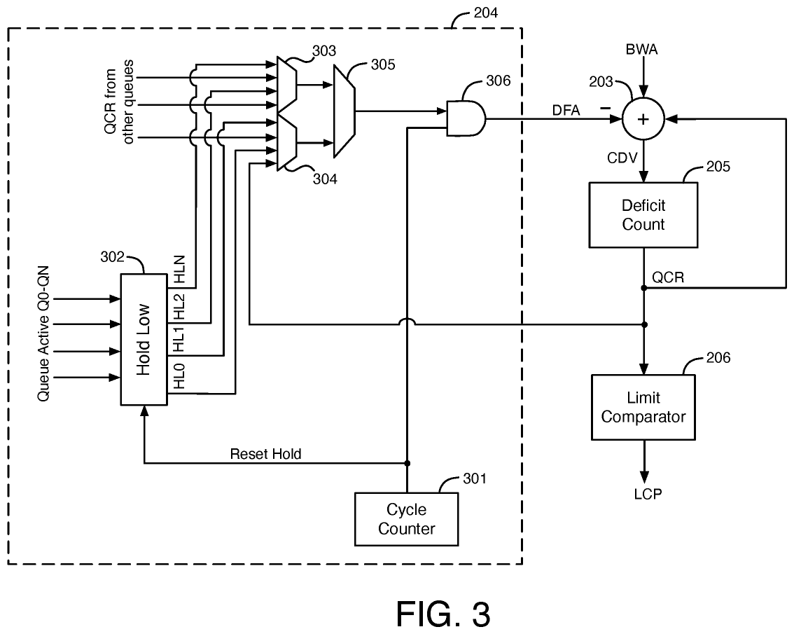

The Feedback signal (i.e., signal OUT) generated by the scheduler circuit 102 is provided to inputs of the traffic shaper circuit 201 and the queue weight adjustment circuit 202. The Feedback signal is indicative of a packet received from one of the queues 101 during the time needed to transmit that packet. The Feedback signal is indicative of packets from all of the queues 101 over a long enough time period. The references to the respective queue 101 in the remaining description of FIGS. 2-3 herein refer to the respective one of the queues 101 that provided the packet(s) most recently indicated by the OUT/Feedback signal being processed by portion 200 for the respective queue 101. The queue weight adjustment circuit 202 allocates an amount of bandwidth BWA (e.g., in bytes) to the respective queue 101 based on the bandwidth of the packet(s) indicated by the Feedback signal. The queue weight adjustment circuit 202 outputs the bandwidth BWA allocated to the respective queue 101. The bandwidth BWA output by queue weight adjustment circuit 202 can equal the bandwidth that the scheduler circuit 102 has scheduled for packets from the respective queue 101 in signal OUT/Feedback over a given time period.

In some implementations, queue weight adjustment circuit 202 can add or subtract an offset to the bandwidth that scheduler circuit 102 has scheduled for packets from the respective queue 101 when generating the output bandwidth BWA. Thus, the amount of bandwidth BWA that queue weight adjustment circuit 202 allocates to the respective queue 101 in a respective portion 200 can be greater than, equal to, or less than the bandwidth allocated to the other queues. One or more output signals of queue weight adjustment circuit 202 that indicate the bandwidth BWA are provided to first inputs of the adder circuit 203.

The adder circuit 203 adds the bandwidth BWA to a deficit count value QCR output by the deficit count circuit 205 to generate a sum. The adder circuit 203 subtracts a deficit allowance value DFA generated by the deficit allowance circuit 204 from the sum of QCR plus BWA to generate a current deficit count value CDV (i.e., CDV=BWA+QCR−DFA). The deficit count circuit 205 (e.g., including one or more storage circuits) receives the current deficit count value CDV at its input and stores the current deficit count value CDV as the deficit count value QCR at its output. The adder circuit 203 and the deficit count circuit 205 cause the deficit count value QCR to indicate the amount of bandwidth (e.g., in terms of the number of bytes of packets) that the scheduler circuit 102 has been providing for transmission of packets from the respective queue 101 to the output OUT. The adder circuit 203 and the deficit count circuit 205 function as a counter that increments the deficit count value QCR by bandwidth BWA, which indicates the size of each packet scheduled and indicated by the Feedback signal. The adder circuit 203 and the deficit count circuit 205 decrement the deficit count value QCR by the deficit allowance value DFA calculated according to a deficit allowance calculation. The adder circuit 203 and the deficit count circuit 205 cause the deficit count value QCR to indicate a running total of the deficit count for the respective queue 101.

The deficit allowance circuit 204 receives the Queue Active Q0-QN signals generated by all of the queues 101 in the packet scheduler circuit 100. Each of the Queue Active signals Q0, Q1, . . . QN indicates whether a respective one of the queues 101A, 101B, . . . 101N is active. At regular time intervals, the deficit count values QCR for all of the queues 101 in the packet scheduler 100 are sampled and transmitted to the deficit allowance circuit 204. Thus, the deficit count circuit 205 in each portion 200 of traffic manager circuit 103 provides its deficit count value QCR to an input of the deficit allowance circuit 204 in each portion 200 at a regularly repeating time interval.

Some clock cycles later (depending on pipelining), the deficit allowance circuit 204 performs and completes the deficit allowance calculation using the deficit count values QCR for all of the active queues 101 in the packet scheduler 100 to generate the deficit allowance value DFA. The deficit allowance circuit 204 only generates the deficit allowance value DFA using the deficit count values QCR for the queues 101 that the Queue Active Q0-QN signals indicate are currently active. The operations performed by the traffic manager circuit 103 are outside the critical path of the scheduler circuit 102, and therefore, the deficit allowance calculation performed by deficit allowance circuit 204 and the addition and subtraction performed by adder circuit 203 are latency insensitive and can be highly pipelined.

The deficit allowance value DFA is provided from an output of the deficit allowance circuit 204 to the minus input (—) of adder circuit 203. The adder circuit 203 in a portion 200 then subtracts the deficit allowance value DFA from the deficit count value QCR plus BWA for the respective queue. During the period of time that the deficit allowance calculation is performed, adder circuit 203 may have also increased the current deficit count value CDV one or more times by the bandwidth BWA allocated for packets from the respective queue 101 that are scheduled by scheduler 102, and in response, the deficit count circuit 205 increased QCR. At the next time interval, the deficit allowance circuit 204 samples the new value of deficit count value QCR from each portion 200 and begins another calculation period to calculate a new deficit allowance value DFA, as described above.

The deficit allowance circuit 204 calculates the deficit allowance value DFA as the minimum deficit count value QCR among all the active queues 101. Active queues are defined as all of the queues 101 that have packets not yet dequeued throughout the entirety of the previous calculation period. That is, if a queue 101 is empty at any point in the calculation period, the queue is considered inactive by the deficit allowance circuit 204. The deficit allowance value DFA can be zero, and also can be greater than the current deficit of one of the inactive queues. The allowance for the inactive queues is clamped so that the queue deficit does not go below zero. If there are no active queues, the deficit allowance value DFA is set to the value of each queue individually (i.e., to reset all queues 101 toward zero deficit).

The limit comparator circuit 206 compares the deficit count value QCR to a deficit count threshold value. A threshold value is set for the deficit count value QCR for all of the queues 101. If the deficit count value QCR increases above the deficit count threshold value, the limit comparator circuit 206 asserts its output LCP to a logic high state, which causes the OR gate circuit 207 to assert the Queue Disable signal for the respective queue 101. In response to the Queue Disable signal for the respective queue 101 being asserted, the respective queue 101 is throttled by disabling the respective queue 101 from sending packets to scheduler circuit 102. The Queue Disable signal can also be asserted by OR gate 207 to disable the respective queue 101 in response to an output signal of traffic shaper circuit 201, which performs a traffic shaping algorithm using a fixed bandwidth value in each time period.

As discussed above, packet scheduler circuit 100 causes all of the queues 101 to be throttled to the rate of the slowest continuously active queue. As a result, the queues 101 storing larger packets are throttled (disabled), and smaller packets stored in the queues 101 are allowed to be scheduled and output by the scheduler circuit 102. This algorithm causes the long-term average transmission of packets by all of the queues 101 to share the available output bandwidth of OUT equally for all packet sizes being sent, independently of the latency of the deficit allowance calculation. A larger latency means the minimum deficit value is larger over time and cancels out. The amount of time for the steady-state bandwidth output by scheduler circuit 102 to be achieved depends on the system latency from a basic round robin decision to the traffic monitor calculation and the value chosen for the deficit count threshold.

FIG. 3 is a diagram that depicts details of an example of the deficit allowance circuit 204. FIG. 3 shows the adder circuit 203, the deficit count circuit 205, and the limit comparator circuit 206. FIG. 3 also shows parts of the deficit allowance circuit 204 including a cycle counter circuit 301, a hold low circuit 302, multiplexer circuits 303-305, and an AND logic gate circuit 306. The cycle counter circuit 301 generates a Reset Hold signal (e.g., every fixed number of clock cycles) that is provided to an input of the hold low circuit 302 and to a first input of the AND gate circuit 306. The deficit count value QCR output by deficit count circuit 205 for the respective queue 101 is provided to one of the inputs of multiplexer circuit 304.

The hold low circuit 302 receives the Queue Active Q0-QN signals generated by all of the queues 101 in the packet scheduler circuit 100. The hold low circuit 302 resets the values of its N output signals HL0-HLN in response to the Reset Hold signal being asserted by the cycle counter circuit 301. The hold low circuit 302 then provides the values of the Queue Active Q0-QN signals to inputs of the multiplexer circuits 303-304 through its N output signals HL0-HLN, as shown in FIG. 3. The deficit count values QCR for all of the queues 101 in the packet scheduler 100 are sampled and provided to additional inputs of the multiplexer circuits 303-304, as shown in FIG. 3. The output signals of the multiplexer circuits 303-304 are provided to inputs of multiplexer circuit 305. The multiplexer circuits 303-305 provide the minimum deficit count value QCR among all of the active queues 101 (as indicated by the Queue Active Q0-QN signals) to a second input of the AND gate circuit 306. The AND gate circuit 306 provides the minimum deficit count value QCR among all of the active queues 101 to the minus input of adder circuit 203 as the deficit allowance value DFA when the Reset Hold signal is in a logic high state.

Adder circuit 203 subtracts DFA from BWA plus QCR for the respective queue 101 to generate the current deficit count value CDV, as described above. Thus, adder circuit 203 subtracts the minimum deficit count value QCR among all of the active queues 101 as indicated by value DFA from the bandwidth BWA allocated to the respective queue 101 plus the deficit count value QCR for the respective queue 101 to generate an updated deficit count value CDV/QCR that is compared to the deficit count threshold value by the limit comparator 206 to determine whether to disable the respective queue 101, as described above.

The traffic manager circuit 103 of FIGS. 1-3 as disclosed herein causes the scheduler circuit 102 to schedule packets from each of the queues 101 at a rate that is determined based on comparing the deficit count value QCR to the deficit count threshold. If any of the queues 101 attempts to send packets through the scheduler circuit 102 that have a total bandwidth greater than allowed by the deficit count threshold in a given time period, the traffic manager circuit 103 disables that queue, as described above. After the deficit count value QCR decreases below the deficit count threshold, the traffic manager circuit 103 enables that queue again for scheduling and transmitting its stored packets through the scheduler circuit 102.

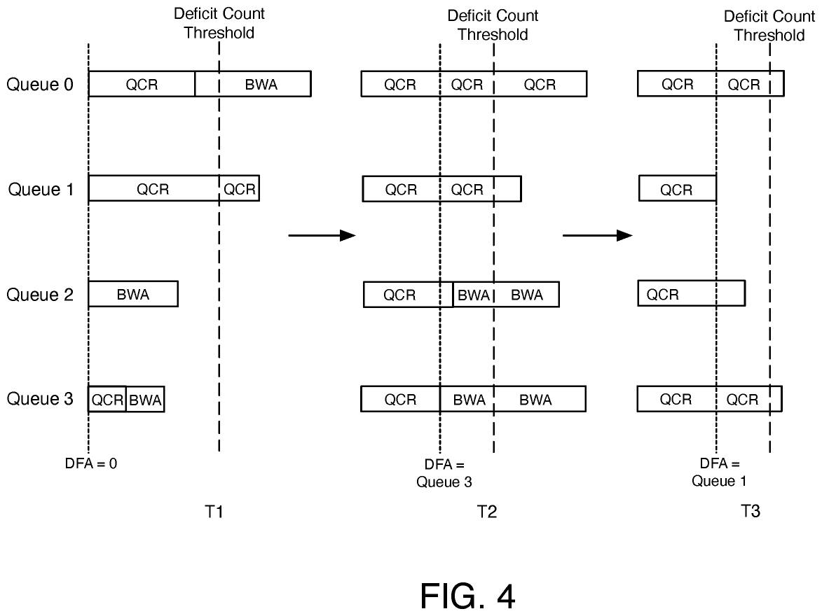

FIG. 4 is a diagram that depicts a graph illustrating examples of the deficit count values and bandwidths for packets sent from queues 101 in the packet scheduler circuit 100 of FIG. 1. In the example shown in FIG. 4, the packet scheduler circuit 100 has 4 queues 101 labeled Queues 0-3. In FIG. 4, the deficit count threshold value is indicated by the vertical dashed lines having long dashes. Also, in FIG. 4, the minimum deficit count value as indicated by the deficit allowance value DFA in each of three different time periods T1-T3 is indicated by a vertical dashed line with short dashes.

In each of the three time periods T1-T3, the deficit count value QCR (if any) and the bandwidth BWA (if any) allocated to each of the Queues 0-3 are shown in FIG. 4. In the first time period T1, QCR plus BWA for Queue 0 and QCR for Queue 1 both exceed the deficit count threshold. As a result, the traffic manager circuit 103 disables Queues 0-1 for the next time period by asserting the Queue Disable Q0-Q1 signals. Also, in time period T1, the bandwidth BWA for Queue 2 and QCR plus BWA for Queue 3 are each less than the deficit count threshold. As a result, the traffic manager circuit 103 causes Queues 2-3 to remain active by keeping Queue Disable signals Q2-Q3 de-asserted. The deficit allowance value DFA in time period T1 equals zero, because the minimum deficit count value of all four Queues 0-3 is zero, which is the deficit count value for Queue 2.

The second time period T2 in FIG. 4 occurs after time period T1. In time period T2, QCR for Queue 0, QCR for Queue 1, QCR plus BWA for Queue 2, and QCR plus BWA for Queue 3 each exceed the deficit count threshold. As a result, the traffic manager circuit 103 disables all four Queues 0-3 in the next time period by asserting the Queue Disable Q0-Q3 signals. The deficit allowance value DFA in time period T2 equals the deficit count value QCR for Queue 3, because the minimum deficit count value of all four Queues 0-3 is the deficit count value for Queue 3. Thus, for the next time period, the deficit allowance value DFA for Queue 3 is subtracted from the deficit count value QCR plus BWA for all four Queues 0-3 by the adder circuits 203 in four portions 200 of traffic manager circuit 103.

The third time period T3 in FIG. 4 occurs after time period T2. In time period T3, QCR for Queue 0 and QCR for Queue 3 both exceed the deficit count threshold. As a result, the traffic manager circuit 103 continues to disable Queues 0 and 3 in the next time period by continuing to assert the Queue Disable signals Q0 and Q3. Also, in time period T3, QCR for Queue 1 and QCR for Queue 2 are each less than the deficit count threshold. As a result, the traffic manager circuit 103 causes Queues 1-2 to be active in the next time period by de-asserting Queue Disable signals Q1-Q2. The deficit allowance value DFA in time period T3 equals the deficit count value QCR for Queue 1, because the minimum deficit count value of all four Queues 0-3 is the deficit count value QCR for Queue 1. Thus, for the next time period, the deficit allowance value DFA for Queue 1 is subtracted from the deficit count value QCR plus BWA for all four Queues 0-3 by the adder circuits 203 in four portions 200 of traffic manager circuit 103.

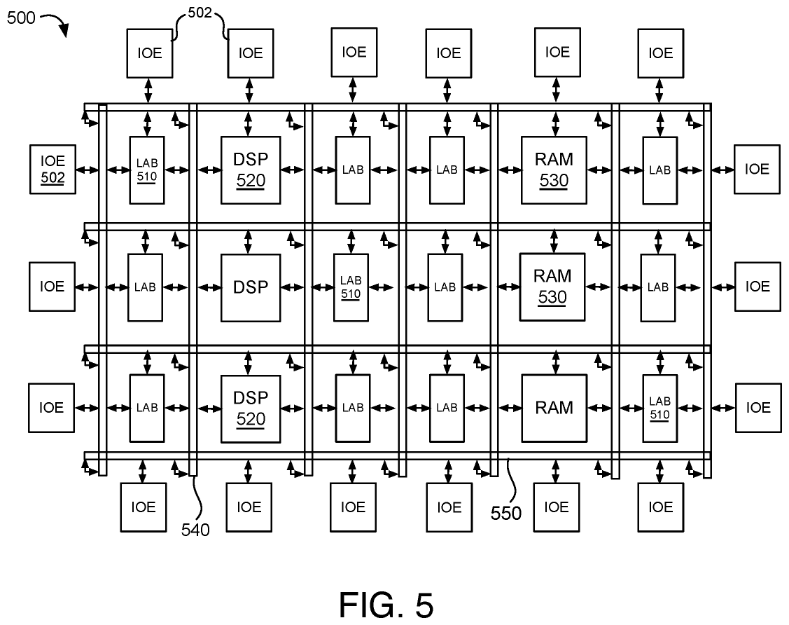

FIG. 5 illustrates an example of a programmable (i.e., configurable) logic integrated circuit (IC) 500 that can include, for example, the circuitry disclosed herein with respect to any, or more, of FIGS. 1-3. Programmable IC 500 can be configured to perform the functions associated with FIG. 4, as an example. As shown in FIG. 5, the programmable logic integrated circuit (IC) 500 includes a two-dimensional array of configurable functional circuit blocks, including configurable logic array blocks (LABs) 510 and other functional circuit blocks, such as random access memory (RAM) blocks 530 and digital signal processing (DSP) blocks 520. Functional blocks such as LABs 510 can include smaller programmable logic circuits (e.g., logic elements, logic blocks, or adaptive logic modules) that receive input signals and perform custom functions on the input signals to produce output signals. The configurable functional circuit blocks shown in FIG. 5 can, for example, be configured to perform the functions of any of the circuitry disclosed herein with respect to FIGS. 1-3.

In addition, programmable logic IC 500 can have input/output elements (IOEs) 502 for driving signals off of programmable logic IC 500 and for receiving signals from other devices. Input/output elements 502 can include parallel input/output circuitry, serial data transceiver circuitry, differential receiver and transmitter circuitry, or other circuitry used to connect one integrated circuit to another integrated circuit. As shown, input/output elements 502 can be located around the periphery of the chip. If desired, the programmable logic IC 500 can have input/output elements 502 arranged in different ways. For example, input/output elements 502 can form one or more columns, rows, or islands of input/output elements that may be located anywhere on the programmable logic IC 500.

The programmable logic IC 500 can also include programmable interconnect circuitry in the form of vertical routing channels 540 (i.e., interconnects formed along a vertical axis of programmable logic IC 500) and horizontal routing channels 550 (i.e., interconnects formed along a horizontal axis of programmable logic IC 500), each routing channel including at least one conductor to route at least one signal.

Note that other routing topologies, besides the topology of the interconnect circuitry depicted in FIG. 5, may be used. For example, the routing topology can include wires that travel diagonally or that travel horizontally and vertically along different parts of their extent as well as wires that are perpendicular to the device plane in the case of three dimensional integrated circuits. The driver of a wire can be located at a different point than one end of a wire.

Furthermore, it should be understood that embodiments disclosed herein with respect to FIGS. 1-4 can be implemented in any integrated circuit or electronic system. If desired, the functional blocks of such an integrated circuit can be arranged in more levels or layers in which multiple functional blocks are interconnected to form still larger blocks. Other device arrangements can use functional blocks that are not arranged in rows and columns.

Programmable logic IC 500 can contain programmable memory elements. Memory elements can be loaded with configuration data using input/output elements (I0Es) 502. Once loaded, the memory elements each provide a corresponding static control signal that controls the operation of an associated configurable functional block (e.g., LABs 510, DSP blocks 520, RAM blocks 530, or input/output elements 502).

In a typical scenario, the outputs of the loaded memory elements are applied to the gates of metal-oxide-semiconductor field-effect transistors (MOSFETs) in a functional block to turn certain transistors on or off and thereby configure the logic in the functional block including the routing paths. Programmable logic circuit elements that can be controlled in this way include multiplexers (e.g., multiplexers used for forming routing paths in interconnect circuits), look-up tables, logic arrays, AND, OR, XOR, NAND, and NOR logic gates, pass gates, etc.

The programmable memory elements can be organized in a configuration memory array having rows and columns. A data register that spans across all columns and an address register that spans across all rows can receive configuration data. The configuration data can be shifted onto the data register. When the appropriate address register is asserted, the data register writes the configuration data to the configuration memory bits of the row that was designated by the address register.

In certain embodiments, programmable logic IC 500 can include configuration memory that is organized in sectors, whereby a sector can include the configuration RAM bits that specify the functions and/or interconnections of the subcomponents and wires in or crossing that sector. Each sector can include separate data and address registers.

The programmable logic IC of FIG. 5 is merely one example of an IC that can be used with embodiments disclosed herein. The embodiments disclosed herein can be used with any suitable integrated circuit or system. For example, the embodiments disclosed herein can be used with numerous types of devices such as processor integrated circuits, central processing units, memory integrated circuits, graphics processing unit integrated circuits, application specific standard products (ASSPs), application specific integrated circuits (ASICs), and programmable logic integrated circuits. Examples of programmable logic integrated circuits include programmable arrays logic (PALs), programmable logic arrays (PLAs), field programmable logic arrays (FPGAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The integrated circuits disclosed in one or more embodiments herein can be part of a data processing system that includes one or more of the following components: a processor; memory; input/output circuitry; and peripheral devices. The data processing system can be used in a wide variety of applications, such as computer networking, data networking, instrumentation, video processing, digital signal processing, or any suitable other application. The integrated circuits can be used to perform a variety of different logic functions.

In general, software and data for performing any of the functions disclosed herein can be stored in non-transitory computer readable storage media. Non-transitory computer readable storage media is tangible computer readable storage media that stores data and software for access at a later time, as opposed to media that only transmits propagating electrical signals (e.g., wires). The software code may sometimes be referred to as software, data, program instructions, instructions, or code. The non-transitory computer readable storage media can, for example, include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s).

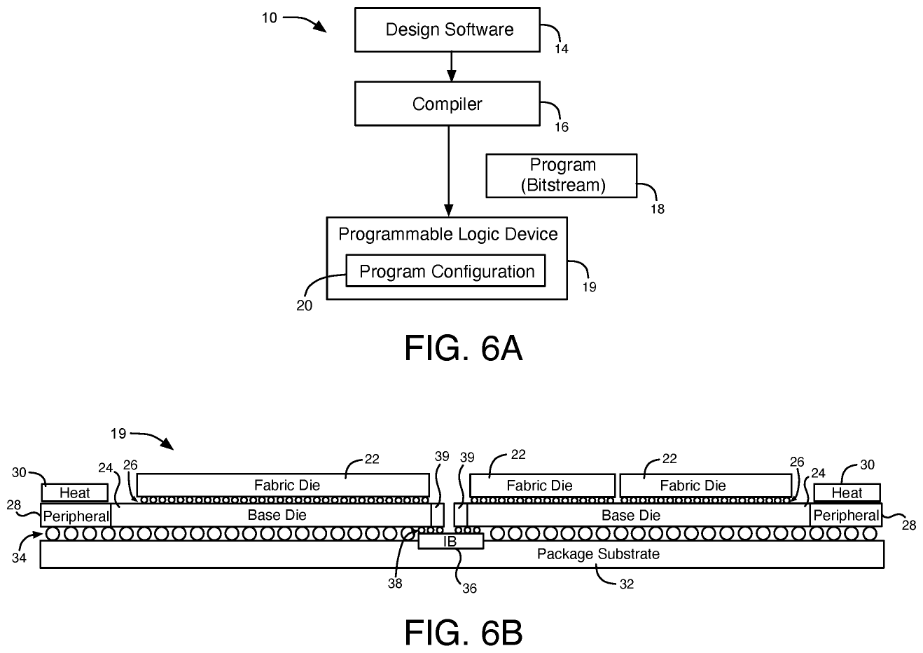

FIG. 6A illustrates a block diagram of a system 10 that can be used to implement a circuit design to be programmed onto a programmable logic device using design software. A designer can implement circuit design functionality on an integrated circuit, such as a reconfigurable programmable logic device 19 (e.g., a field programmable gate array (FPGA)). The designer can implement a circuit design to be programmed onto the programmable logic device 19 using design software 14. The design software 14 can use a compiler 16 to generate a low-level circuit-design program (bitstream) 18, sometimes known as a program object file and/or configuration program, that programs the programmable logic device 19. Thus, the compiler 16 can provide machine-readable instructions representative of the circuit design to the programmable logic device 19. For example, the programmable logic device 19 can receive one or more programs (bitstreams) 18 that describe the hardware implementations that should be stored in the programmable logic device 19. A program (bitstream) 18 can be programmed into the programmable logic device 19 as a configuration program 20. The configuration program 20 can, in some cases, represent an accelerator function to perform for machine learning, video processing, voice recognition, image recognition, or other highly specialized task.

The programmable logic device 19 can, for example, represent any integrated circuit device that includes a programmable logic device with two separate integrated circuit die where at least some of the programmable logic fabric is separated from at least some of the fabric support circuitry that operates the programmable logic fabric. One example of the programmable logic device 19 is shown in FIG. 6B, but many others can be used, and it should be understood that this disclosure is intended to encompass any suitable programmable logic device 19 where programmable logic fabric and fabric support circuitry are at least partially separated on different integrated circuit die.

FIG. 6B is a diagram that depicts an example of the programmable logic device 19 that includes three fabric die 22 and two base die 24 that are connected to one another via microbumps 26. In the example of FIG. 6B, at least some of the programmable logic fabric of the programmable logic device 19 is in the three fabric die 22, and at least some of the fabric support circuitry that operates the programmable logic fabric is in the two base die 24. For example, some of the circuitry of programmable IC 500 shown in FIG. 5 (e.g., LABs 510, DSP 520, RAM 530) can be located in the fabric die 22 and some of the circuitry of IC 500 (e.g., input/output elements 502) can be located in the base die 24.

Although the fabric die 22 and base die 24 appear in a one-to-one relationship or a two-to-one relationship in FIG. 6B, other relationships can be used. For example, a single base die 24 can attach to several fabric die 22, or several base die 24 can attach to a single fabric die 22, or several base die 24 can attach to several fabric die 22 (e.g., in an interleaved pattern). Peripheral circuitry 28 can be attached to, embedded within, and/or disposed on top of the base die 24, and heat spreaders 30 can be used to reduce an accumulation of heat on the programmable logic device 19. The heat spreaders 30 can appear above, as pictured, and/or below the package (e.g., as a double-sided heat sink). The base die 24 can attach to a package substrate 32 via conductive bumps 34. In the example of FIG. 6B, two pairs of fabric die 22 and base die 24 are shown communicatively connected to one another via an interconnect bridge 36 (e.g., an embedded multi-die interconnect bridge (EMIB)) and microbumps 38 at bridge interfaces 39 in base die 24.

In combination, the fabric die 22 and the base die 24 can operate in combination as a programmable logic device 19 such as a field programmable gate array (FPGA). It should be understood that an FPGA can, for example, represent the type of circuitry, and/or a logical arrangement, of a programmable logic device when both the fabric die 22 and the base die 24 operate in combination. Moreover, an FPGA is discussed herein for the purposes of this example, though it should be understood that any suitable type of programmable logic device can be used.

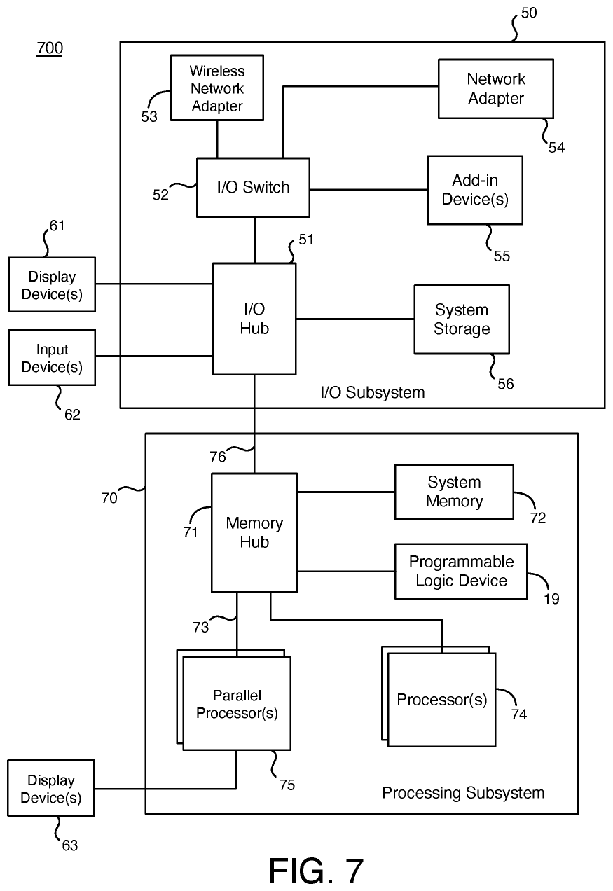

FIG. 7 is a block diagram illustrating a computing system 700 configured to implement one or more aspects of the embodiments described herein. The computing system 700 includes a processing subsystem 70 having one or more processor(s) 74, a system memory 72, and a programmable logic device 19 communicating via an interconnection path that can include a memory hub 71. The memory hub 71 can be a separate component within a chipset component or can be integrated within the one or more processor(s) 74. The memory hub 71 couples with an input/output (I/O) subsystem 50 via a communication link 76. The I/O subsystem 50 includes an input/output (I/O) hub 51 that can enable the computing system 700 to receive input from one or more input device(s) 62. Additionally, the I/O hub 51 can enable a display controller, which can be included in the one or more processor(s) 74, to provide outputs to one or more display device(s) 61. In one embodiment, the one or more display device(s) 61 coupled with the I/O hub 51 can include a local, internal, or embedded display device.

In one embodiment, the processing subsystem 70 includes one or more parallel processor(s) 75 coupled to memory hub 71 via a bus or other communication link 73. The communication link 73 can use one of any number of standards based communication link technologies or protocols, such as, but not limited to, PCI Express, or can be a vendor specific communications interface or communications fabric. In one embodiment, the one or more parallel processor(s) 75 form a computationally focused parallel or vector processing system that can include a large number of processing cores and/or processing clusters, such as a many integrated core (MIC) processor. In one embodiment, the one or more parallel processor(s) 75 form a graphics processing subsystem that can output pixels to one of the one or more display device(s) 61 coupled via the I/O Hub 51. The one or more parallel processor(s) 75 can also include a display controller and display interface (not shown) to enable a direct connection to one or more display device(s) 63.

Within the I/O subsystem 50, a system storage unit 56 can connect to the I/O hub 51 to provide a storage mechanism for the computing system 700. An I/O switch 52 can be used to provide an interface mechanism to enable connections between the I/O hub 51 and other components, such as a network adapter 54 and/or a wireless network adapter 53 that can be integrated into the platform, and various other devices that can be added via one or more add-in device(s) 55. The network adapter 54 can be an Ethernet adapter or another wired network adapter. The wireless network adapter 53 can include one or more of a Wi-Fi, Bluetooth, near field communication (NFC), or other network device that includes one or more wireless radios.

The computing system 700 can include other components not shown in FIG. 7, including other port connections, optical storage drives, video capture devices, and the like, that can also be connected to the I/O hub 51. Communication paths interconnecting the various components in FIG. 7 can be implemented using any suitable protocols, such as PCI (Peripheral Component Interconnect) based protocols (e.g., PCI-Express), or any other bus or point-to-point communication interfaces and/or protocol(s), such as the NV-Link high-speed interconnect, or interconnect protocols known in the art.

In one embodiment, the one or more parallel processor(s) 75 incorporate circuitry optimized for graphics and video processing, including, for example, video output circuitry, and constitutes a graphics processing unit (GPU). In another embodiment, the one or more parallel processor(s) 75 incorporate circuitry optimized for general purpose processing, while preserving the underlying computational architecture. In yet another embodiment, components of the computing system 700 can be integrated with one or more other system elements on a single integrated circuit. For example, the one or more parallel processor(s) 75, memory hub 71, processor(s) 74, and I/O hub 51 can be integrated into a system on chip (SoC) integrated circuit. Alternatively, the components of the computing system 700 can be integrated into a single package to form a system in package (SIP) configuration. In one embodiment, at least a portion of the components of the computing system 700 can be integrated into a multi-chip module (MCM), which can be interconnected with other multi-chip modules into a modular computing system.

The computing system 700 shown herein is illustrative. Other variations and modifications are also possible. The connection topology, including the number and arrangement of bridges, the number of processor(s) 74, and the number of parallel processor(s) 75, can be modified as desired. For instance, in some embodiments, system memory 72 is connected to the processor(s) 74 directly rather than through a bridge, while other devices communicate with system memory 72 via the memory hub 71 and the processor(s) 74. In other alternative topologies, the parallel processor(s) 75 are connected to the I/O hub 51 or directly to one of the one or more processor(s) 74, rather than to the memory hub 71. In other embodiments, the I/O hub 51 and memory hub 71 can be integrated into a single chip. Some embodiments can include two or more sets of processor(s) 74 attached via multiple sockets, which can couple with two or more instances of the parallel processor(s) 75.

Some of the particular components shown herein are optional and may not be included in all implementations of the computing system 700. For example, any number of add-in cards or peripherals can be supported, or some components can be eliminated. Furthermore, some architectures can use different terminology for components similar to those illustrated in FIG. 7. For example, the memory hub 71 can be referred to as a Northbridge in some architectures, while the I/O hub 51 can be referred to as a Southbridge.

Additional examples are now described. Example 1 is an integrated circuit comprising: a queue circuit for storing first packets; a scheduler circuit for scheduling second packets received from the queue circuit to be provided in an output; and a traffic manager circuit for disabling the queue circuit from transmitting the first packets to the scheduler circuit based at least in part on a bandwidth in the output scheduled for the second packets received from the queue circuit.

In Example 2, the integrated circuit of Example 1 can optionally include, wherein the traffic manager circuit comprises a deficit allowance circuit that calculates a deficit allowance value as a minimum value of deficit count values that the traffic manager circuit generates for queues that are active, and wherein the queues comprise the queue circuit.

In Example 3, the integrated circuit of Example 2 can optionally include, wherein the traffic manager circuit further comprises an adder circuit that subtracts the deficit allowance value from the bandwidth to generate a first one of the deficit count values.

In Example 4, the integrated circuit of Example 3 can optionally include, wherein the adder circuit adds a previous value of the first one of the deficit count values to the bandwidth to generate a sum and subtracts the deficit allowance value from the sum to generate an updated value of the first one of the deficit count values.

In Example 5, the integrated circuit of any one of Examples 3-4 can optionally include, wherein the traffic manager circuit further comprises a comparator circuit that compares the first one of the deficit count values to a threshold value to determine when to disable the queue circuit from transmitting any of the first packets to the scheduler circuit.

In Example 6, the integrated circuit of any one of Examples 3-5 can optionally include, wherein the traffic manager circuit further comprises a deficit count storage circuit that stores the first one of the deficit count values generated by the adder circuit.

In Example 7, the integrated circuit of any one of Examples 2-6 can optionally include, wherein the deficit allowance circuit comprises multiplexer circuits that select and output the deficit allowance value as the minimum value of the deficit count values generated for queues that are active, and wherein the multiplexer circuits receive signals indicating which queues are active.

In Example 8, the integrated circuit of any one of Examples 1-7 can optionally include, wherein the traffic manager circuit disables the queue circuit from transmitting any of the first packets to the scheduler circuit based in part on a minimum size of third packets scheduled by the scheduler circuit for any queues over a time period.

In Example 9, the integrated circuit of any one of Examples 1-8 can optionally include, wherein the traffic manager circuit causes an average transmission of third packets by all queues to share a total bandwidth of the output equally.

Example 10 is a method for controlling transmission of first packets and second packets, the method comprising: storing the first packets in a first queue circuit; storing the second packets in a second queue circuit; scheduling the first packets received from the first queue circuit using a scheduler circuit; and throttling the second queue circuit from providing the second packets to the scheduler circuit using a traffic manager circuit based in part on a minimum amount of bandwidth scheduled by the scheduler circuit for the first and the second queue circuits.

In Example 11, the method of Example 10 further comprises: generating a deficit allowance value based on the minimum amount of the bandwidth scheduled by the scheduler circuit for the first and the second queue circuits that are active.

In Example 12, the method of Example 11 further comprises: adding a previous value of a deficit count value to an amount of the first packets scheduled by the scheduler circuit for the first queue circuit to generate a sum; and subtracting the deficit allowance value from the sum to generate an updated value of the deficit count value.

In Example 13, the method of Example 12 further comprises: comparing the updated value of the deficit count value to a threshold to determine when to throttle the second queue circuit from providing any of the second packets stored in the second queue circuit to the scheduler circuit.

In Example 14, the method of any one of Examples 10-13 further comprises: generating deficit count values for the first and the second queue circuits based on the first packets scheduled from the first queue circuit using the traffic manager circuit; and determining the minimum amount of the bandwidth scheduled by the scheduler circuit for any of the first and the second queue circuits based on a minimum value of the deficit count values.

In Example 15, the method of any one of Examples 10-14 can optionally include, wherein scheduling the first packets from the first queue circuit using the scheduler circuit comprises scheduling the first packets using a basic round robin scheduler algorithm.

Example 16 is a non-transitory computer readable storage medium comprising computer readable instructions stored thereon for causing an integrated circuit to: provide packets stored in queue circuits; provide the packets received from the queue circuits to an output using a scheduler circuit; and disable one of the queue circuits from providing any additional ones of the packets to the scheduler circuit based at least in part on a bandwidth in the output scheduled for a subset of the packets from the one of the queue circuits.

In Example 17, the non-transitory computer readable storage medium of Example 16 can optionally include, wherein the computer readable instructions further cause the integrated circuit to disable the one of the queue circuits from providing the any additional ones of the packets to the scheduler circuit based in part on a minimum size of the packets scheduled by the scheduler circuit for any of the queue circuits over a time period.

In Example 18, the non-transitory computer readable storage medium of any one of Examples 16-17 can optionally include, wherein the computer readable instructions further cause the integrated circuit to add a previous count value for the one of the queue circuits to the bandwidth to generate a sum and subtract an allowance value from the sum to generate an updated count value that is used to determine when to disable the one of the queue circuits from providing the any additional ones of the packets to the scheduler circuit.

In Example 19, the non-transitory computer readable storage medium of any one of Examples 16-18, wherein the computer readable instructions further cause the integrated circuit to compare a count value maintained for the one of the queue circuits to a threshold to determine when to disable the one of the queue circuits from providing the any additional ones of the packets to the scheduler circuit.

In Example 20, the non-transitory computer readable storage medium of any one of Examples 16-19, wherein the computer readable instructions further cause the integrated circuit to cause an average transmission of the packets by all of the queue circuits to share space in the output equally over time.

The foregoing description of the examples has been presented for the purpose of illustration. The foregoing description is not intended to be exhaustive or to be limiting to the examples disclosed herein. In some instances, features of the examples can be employed without a corresponding use of other features as set forth. Many modifications, substitutions, and variations are possible in light of the above teachings.

What is claimed is:

1. An integrated circuit comprising:
a queue circuit for storing first packets;
a scheduler circuit for scheduling second packets received from the queue circuit to be provided in an output; and
a traffic manager circuit for disabling the queue circuit from transmitting the first packets to the scheduler circuit based at least in part on a bandwidth in the output scheduled for the second packets received from the queue circuit.

2. The integrated circuit of claim 1, wherein the traffic manager circuit comprises a deficit allowance circuit that calculates a deficit allowance value as a minimum value of deficit count values that the traffic manager circuit generates for queues that are active, and wherein the queues comprise the queue circuit.

3. The integrated circuit of claim 2, wherein the traffic manager circuit further comprises an adder circuit that subtracts the deficit allowance value from the bandwidth to generate a first one of the deficit count values.

4. The integrated circuit of claim 3, wherein the adder circuit adds a previous value of the first one of the deficit count values to the bandwidth to generate a sum and subtracts the deficit allowance value from the sum to generate an updated value of the first one of the deficit count values.

5. The integrated circuit of claim 3, wherein the traffic manager circuit further comprises a comparator circuit that compares the first one of the deficit count values to a threshold value to determine when to disable the queue circuit from transmitting any of the first packets to the scheduler circuit.

6. The integrated circuit of claim 3, wherein the traffic manager circuit further comprises a deficit count storage circuit that stores the first one of the deficit count values generated by the adder circuit.

7. The integrated circuit of claim 2, wherein the deficit allowance circuit comprises multiplexer circuits that select and output the deficit allowance value as the minimum value of the deficit count values generated for the queues that are active, and wherein the multiplexer circuits receive signals indicating which of the queues are active.

8. The integrated circuit of claim 1, wherein the traffic manager circuit disables the queue circuit from transmitting any of the first packets to the scheduler circuit based in part on a minimum size of third packets scheduled by the scheduler circuit for any queues over a time period.

9. The integrated circuit of claim 1, wherein the traffic manager circuit causes an average transmission of third packets by all queues to share a total bandwidth of the output equally.

10. A method for controlling transmission of first packets and second packets, the method comprising:
storing the first packets in a first queue circuit;
storing the second packets in a second queue circuit;
scheduling the first packets received from the first queue circuit using a scheduler circuit; and
throttling the second queue circuit from providing the second packets to the scheduler circuit using a traffic manager circuit based in part on a minimum amount of bandwidth scheduled by the scheduler circuit for the first and the second queue circuits.

11. The method of claim 10 further comprising:
generating a deficit allowance value based on the minimum amount of the bandwidth scheduled by the scheduler circuit for the first and the second queue circuits that are active.

12. The method of claim 11 further comprising:
adding a previous value of a deficit count value to an amount of the first packets scheduled by the scheduler circuit for the first queue circuit to generate a sum; and
subtracting the deficit allowance value from the sum to generate an updated value of the deficit count value.

13. The method of claim 12 further comprising:
comparing the updated value of the deficit count value to a threshold to determine when to throttle the second queue circuit from providing any of the second packets stored in the second queue circuit to the scheduler circuit.

14. The method of claim 10 further comprising:
generating deficit count values for the first and the second queue circuits based on the first packets scheduled from the first queue circuit using the traffic manager circuit; and
determining the minimum amount of the bandwidth scheduled by the scheduler circuit for any of the first and the second queue circuits based on a minimum value of the deficit count values.

15. The method of claim 10, wherein scheduling the first packets from the first queue circuit using the scheduler circuit comprises scheduling the first packets using a basic round robin scheduler algorithm.

16. A non-transitory computer readable storage medium comprising computer readable instructions stored thereon for causing an integrated circuit to:
provide packets stored in queue circuits;
provide the packets received from the queue circuits to an output using a scheduler circuit; and
disable one of the queue circuits from providing any additional ones of the packets to the scheduler circuit based at least in part on a bandwidth in the output scheduled for a subset of the packets from the one of the queue circuits.

17. The non-transitory computer readable storage medium of claim 16, wherein the computer readable instructions further cause the integrated circuit to disable the one of the queue circuits from providing the any additional ones of the packets to the scheduler circuit based in part on a minimum size of the packets scheduled by the scheduler circuit for any of the queue circuits over a time period.

18. The non-transitory computer readable storage medium of claim 16, wherein the computer readable instructions further cause the integrated circuit to add a previous count value for the one of the queue circuits to the bandwidth to generate a sum and subtract an allowance value from the sum to generate an updated count value that is used to determine when to disable the one of the queue circuits from providing the any additional ones of the packets to the scheduler circuit.

19. The non-transitory computer readable storage medium of claim 16, wherein the computer readable instructions further cause the integrated circuit to compare a count value maintained for the one of the queue circuits to a threshold to determine when to disable the one of the queue circuits from providing the any additional ones of the packets to the scheduler circuit.

20. The non-transitory computer readable storage medium of claim 16, wherein the computer readable instructions further cause the integrated circuit to cause an average transmission of the packets by all of the queue circuits to share space in the output equally over time.
